(19) United States
(12) Patent Application Publication
(10) Pub. No.: US 2019/0286843 A1
(43) Pub. Date: Sep. 19, 2019

(54) DATA DELIVERY CONTROL DEVICE, INFORMATION PROCESSING DEVICE, AND METHOD FOR DATA DELIVERY CONTROL

(71) Applicant: HONDA MOTOR CO., LTD., Tokyo (JP)

(72) Inventors: Kichinosuke Fukuhara, Tokyo (JP); Kei Nakajima, Tokyo (JP)

(21) Appl. No.: 16/290,166

(22) Filed: Mar. 1, 2019

(30) Foreign Application Priority Data
Mar. 13, 2018 (JP) 2018-045311

(51) Int. Cl. G06F 21/62

(52) U.S. Cl. CPC G06F 21/6245; G07C 5/008

(57) ABSTRACT

A data delivery control device is configured to comprise: a user data management unit which manages collected data containing information concerning a car and information on a user's act of the car; a demand value management unit which manages a demand value for the collected data which is demanded for by a demander; a data comparison unit which compares the collected data with the demand value; a provision permission/non-permission acquisition unit which, if demand-matched data which matches with the demand value is included in the collected data, obtains the user's permission/non-permission to provide the demand-matched data; and a data transmission control unit which transmits the demand-matched data to allow the demander to obtain the demand-matched data according to the user's permission/non-permission.

### INCORPORATION BY REFERENCE

The present application claims priority under 35 U.S.C.§ 119 to Japanese Patent Application No. 2018-045311 filed on Mar. 13, 2018. The content of the application is incorporated herein by reference in its entirety.

### BACKGROUND OF THE INVENTION

### Field of the Invention

The present invention relates to a data delivery control device, an information processing device, and a method for data delivery control.

### Description of the Related Art

A technology where image data obtained by a car is delivered to a third party unrelated to the car so that the image data can be seen by the party is known (refer to, for example, Japanese Patent Laid-Open No. 2017-69917).

The data delivered to the third party may contain information concerning the privacy of the user of the car or information concerning individuals (hereinafter referred to as “personal information”). The conventional art, however, allows personal information to be delivered to the party without regard to the user's intent.

The present invention is to provide a data delivery control device, an information processing device, and a method for data delivery control that can prevent the delivery of personal information that the user does not want.

### SUMMARY OF THE INVENTION

An aspect of the present invention provides a data delivery control device comprising: a user data management unit which manages user personal information containing information concerning a vehicle and information concerning the user's act of the vehicle; a demand value management unit which manages demand values for user personal information which is demanded for by a demander; a data comparison unit which compares the user personal information under management of the user data management unit with the demand value under management of the demand value management unit; a provision permission/non-permission acquisition unit which, if a result of data comparison by the data comparison unit indicates that the user personal information includes a demand-matched data that matches with the demand value, acquires permission/non-permission of the user to provide the demand-matched data; and a data transmission control unit which transmits the demand-matched data to allow the demander to obtain the demand-matched data according to the user's permission/non-permission acquired by the provision permission/non-permission acquisition unit.

In the aspect of the present invention, the demand value management unit of the data delivery control device manages a reward offered by the demander for the provision of the demand-matched data.

In the aspect of the present invention, the provision permission/non-permission acquisition unit of the data delivery control device presents the reward to the user and inquires of the user about permission/non-permission to provide the demand-matched data.

In the aspect of the present invention, the vehicle with the data delivery control device may be a car, and user personal information may be organized into data for a unit period between an ignition key being turned into the on position and the ignition key being turned into the off position in the car.

In the aspect of the present invention, the information concerning the user's act in the data delivery control device may include information concerning the location of the car.

In the aspect of the present invention, the information concerning the user's act in the data delivery control device may include date and time information.

An aspect of the present invention provides an information processing device comprising an interface unit to which the user can input his or her permission/non-permission to provide the demand-matched data identified in the comparison by the data delivery control device as described in any one of the above paragraphs, and a response control unit which transmits permission/non-permission to provide the demand-matched data to the data delivery control device on the basis of the user's input to the interface unit.

An aspect of the present invention provides a method for data delivery control in a data delivery control device comprising a user data management unit which manages user personal information containing information concerning a vehicle and information concerning a user's act of the vehicle, the method comprising: a step of obtaining demand values for user personal information demanded by a demander; a step of comparing the user personal information under management of the user data management unit with the demand value; a step of, if a demand-matched data which matches with the demand value is included in the user personal information, acquiring the user's permission/non-permission to provide the demand-matched data; and a step of transmitting the demand-matched data to allow the demander to obtain the demand-matched data according to the user's permission/non-permission.

In the aspect of the present invention, the method for data delivery control may comprise a step in which the demander offers a reward for the provision of the demand-matched data.

In the aspect of the present invention, the method for data delivery control is provided wherein the reward is presented to the user; the user is inquired of about permission/non-permission to provide the demand-matched data; and the user's permission/non-permission is obtained on the basis of the user's reply to the inquiry.

The aspect of the present invention makes it possible to prevent user personal information from being transmitted without regard to his or her intent.

### BRIEF DESCRIPTION OF THE DRAWINGS

FIG. 1 is a schematic view showing a configuration of a data delivery system in an embodiment of the present invention;

FIG. 2 is a schematic view showing a configuration of an on-vehicle system, together with a configuration of an on-vehicle device;

FIG. 3 is a block diagram showing a functional configuration of the data delivery control device;

FIG. 4 is a schematic view showing a configuration of a demand value management database;

FIG. 5 is a sequence chart showing the operations of a data delivery system; and

FIG. 6 shows an example of a reply screen.

### DETAILED DESCRIPTION OF THE PREFERRED EMBODIMENT

An embodiment of the present invention is described here with reference to drawings.

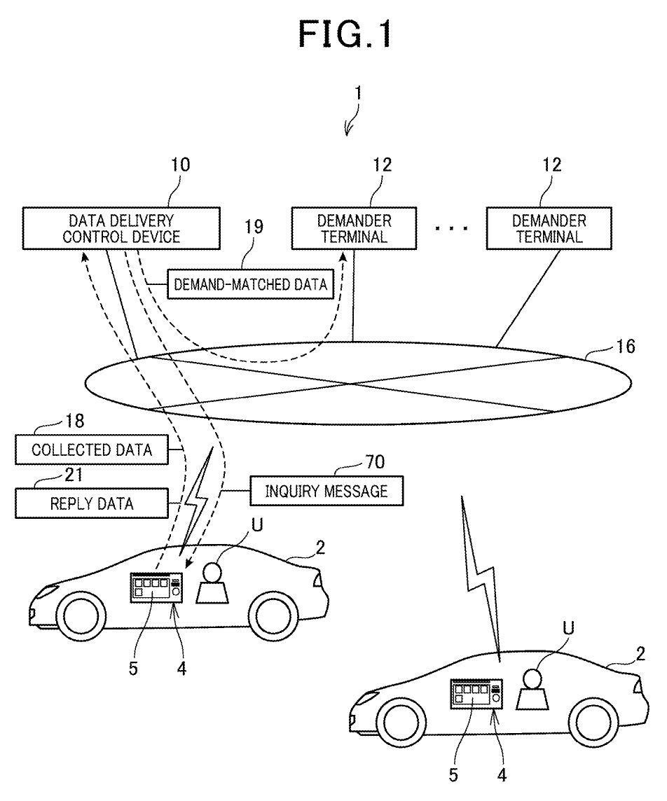

FIG. 1 is a schematic view showing a configuration of a data delivery system 1 in this embodiment.

The data delivery system 1 comprises an on-vehicle device 4 installed in each of a plurality of cars 2, a data delivery control device 10, and a plurality of demander terminals 12, which are communicably connected by telecommunication lines 16. The telecommunication lines 16 comprise a mobile communication network (e.g., a mobile phone network) which provides mobile communication and a network which provides wide area communications, for example, the Internet.

The cars 2 are vehicles each of which is powered with a motor, such as an internal combustion engine, a hybrid engine or an electric motor to travel. In this embodiment, the cars 2 are four-wheel automobiles, however, they may be other types of car such as a motor bike, and further, they are not limited to automobiles, but may be railway train cars.

The on-vehicle device 4 is an information processing device installed in each of the cars 2, and configured as an on-vehicle information collection device having the function of collecting various kinds of data from each of the cars 2. The on-vehicle device 4 transmits collected data 18 to the data delivery control device 10 through the telecommunication lines 16. The on-vehicle device 4, is provided with a touch panel display 5, which is an example of a user interface, and is installed in each of the cars 2 so that a user U (for example, the owner of one of the cars 2) can operate it.

The data delivery control device 10 receives the collected data 18 transmitted from each on-vehicle device 4 via telecommunication lines 16, and manages the collected data 18. In addition, the data delivery control device 10 extracts demand-matched data 19 that matches with the demander demand from the collected data 18, and delivers the demand-matched data 19 to the demander terminal 12 through the telecommunication lines 16.

Each of the demander terminal 12 is a communication terminal by which a demander who may use data included in the collected data 18 for various purposes receives the delivery of the data through the telecommunication lines 16. The demander terminal 12 may be a common computer (i.e., a PC) comprising a user input device (e.g., a keyboard or a touch panel display), a display device, and a communication unit which can be communicably connected to the telecommunication lines 16. The demander may be a corporate company or an organization which provides services related to cars 2, for example, the manufacturer of cars 2, a sales company for cars 2, or an automotive service company.

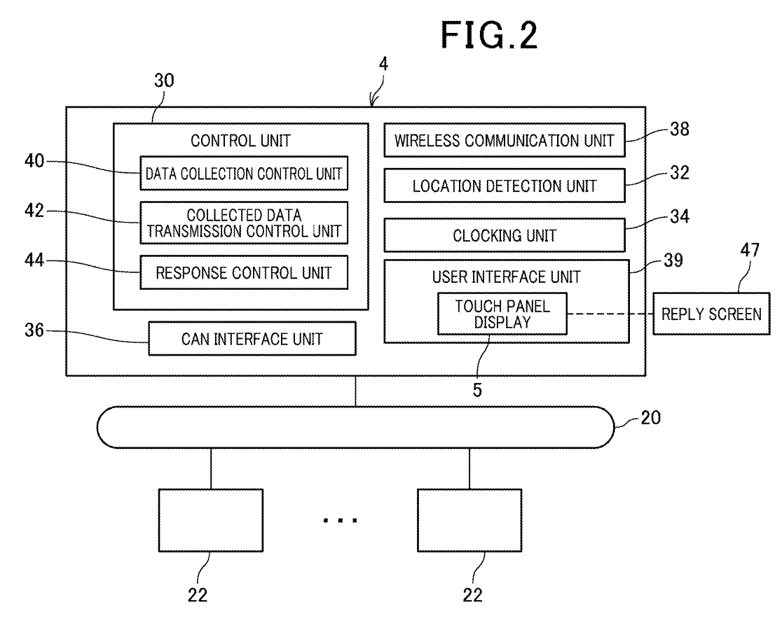

FIG. 2 is a schematic view showing a configuration of the on-vehicle system together with a configuration of the on-vehicle device 4.

The on-vehicle system is installed in each of the cars 2, and comprises a CAN (Controller Area Network) 20, a plurality of electronic control units 22, and the on-vehicle device 4.

The CAN 20, which is an example of a network for a car (also called as an on-vehicle network), is connected to the electronic control units 22 and the on-vehicle device 4, which communicate according to the CAN communication protocol.

The electronic control units 22 are electronic circuit units, and abbreviated as “ECU”. The electronic control units 22 provided in the car 2 may be, for example, an electronic circuit unit which controls the operation of the power train including the engine, an electronic circuit unit which controls the transmission, or an electronic circuit unit which controls the electric equipment. The electric equipment includes, for example, a wiper, a door lock, interior lights, a direction indicator and a tail lamp.

Each of the electronic control units 22 is given a unique identification, and the on-vehicle device 4 can communicate with each of the electronic control units 22, using its identification.

The on-vehicle device 4 comprises a control unit 30, a location detection unit 32, a clocking unit 34, a CAN interface unit 36, a wireless communication unit 38, and a user interface unit 39.

The control unit 30, comprising a processor such as a CPU or an MPU, and a memory device such as a RAM or a ROM, controls each component of the on-vehicle device 4 with the processor operating according to given computer programs.

The location detection unit 32, comprising a positioning device such as a GPS device, detects the current location (information on current latitude and longitude).

The clocking unit 34, comprising a time-measuring circuit, recognizes the current time, and measures time and days.

The CAN interface unit 36 is used to connect to the CAN 20.

The wireless communication unit 38 comprises a wireless communication device which is connected to the telecommunication lines 16 by wireless communication.

The user interface unit 39, provided with the touch panel display 5, has the function of an input device which enables inputs for user operations, and the function of a display device which displays a GUI (Graphical User Interface) which shows various operation screens, messages, etc.

In addition, the control unit 30 works as a data collection control unit 40, a collected data transmission control unit 42, and response control unit 44 by executing computer programs.

The data collection control unit 40 communicates with each of the electronic control units 22 via the CAN interface unit 36, and obtains various types of data from the electronic control units 22 to collect such data from the cars 2. The collected data is stored in a memory device provided in the control unit 30 and a storage device (a disk drive such as an HDD or an SSD) provided in the on-vehicle device 4.

The data collection control unit 40 recognizes a period between the ignition key for each of the cars 2 being turned into the on position and the ignition key being turned into the off position as one drive, and organizes the collected data according to the drive into the collected data 18. The collected data 18 contains the travel time, the travel distance, fuel cost, the locations and dates/times of the ignition key turned into the on and off positions, the trouble code indications by which the types of trouble, if any, that have occurred in each car 2 are identified, the lighting up of warning lights, the car condition of each car for some seconds before, and some seconds after, the occurrence of each of the trouble codes, or the lighting up of warning lights etc., at any time in the period of each one drive. The car condition information indicates the condition of each cars 2, and can be obtained from each of the electronic control units 22. If a car 2 is an electric motor automobile or a hybrid automobile, the collected data 18 also contains the power consumption and the state of charge of the battery in vehicle travelling.

The information of the collected data 18 is obtained directly from the location detection unit 32, the clocking unit 34 and each of the electronic control units 22, or by the data collection control unit 40 analyzing and processing data therefrom. The collected data 18 for one drive is generated by data collection control unit 40, for example, when the ignition key is turned into the off position, and stored in the memory device.

In the collected data 18, the trouble code indications by which the types of trouble, if any, that have occurred in each car 2 are identified, the history of lighting up of warning lights, and car condition information, concern the car 2, but are unrelated to the user U. On the other hand, dates and time, and locations of the ignition key being for the car 2 turned into the on or off position, and a travel time and distance of the car 2, are information concerning an act of the user U that indicates his or her act at that time. Such information concerning an act does not by itself make it possible to identify the user U; however, checking it with, for example, other information concerning the car 2 makes it possible to identify the user U; therefore, they belong to personal information.

Accordingly, the collected data 18 contains information concerning acts of the user U and information concerning the car 2, and is user personal information.

The data collection control unit 40 may collect any type of information other than those mentioned above.

If other on-vehicle apparatuses such as a navigation device having a location detection unit, or an electronic control unit 22, is connected to the CAN 20, the data collection control unit 40 may obtain the current location from such on-vehicle apparatuses or the electronic control unit 22. In that case, the user interface unit 39 of the on-vehicle device 4 may also work as an operation interface for operating the functions of other on-vehicle apparatuses.

The collected data transmission control unit 42 read out the collected data 18 from the memory device or the like at predetermined times, and transmits the collected data 18 to the data delivery control device 10 by communication of the wireless communication unit 38. The collected data 18 is recorded for each one drive as mentioned above, and in the transmission of collected data 18, all the collected data 18 that has not been transmitted is sent. Transmitting the collected data may be set at any time; and the time of a certain event such as the ignition key turned into the on or off position, or any other time when the on-vehicle device 4 is able to operate, may be the time for transmitting the collected data 18.

The response control unit 44 responds to communication from the data delivery control device 10. The communication received from the data delivery control device 10 may be an inquiry message 70, mentioned below, which is an inquiry request to the user U (FIG. 1). When the response control unit 44 receives the inquiry message 70, it shows a reply screen 47 on the user interface unit 39 according to the inquiry message 70. The reply screen 47 presents the content of inquiry of the inquiry message 70 to the user U, and receives a reply to the inquiry from the user U. If the user U inputs a reply on the reply screen 47, the response control unit 44 transmits reply data 21 (FIG. 1) having the content of reply to the data delivery control device 10 by communication of the wireless communication unit 38.

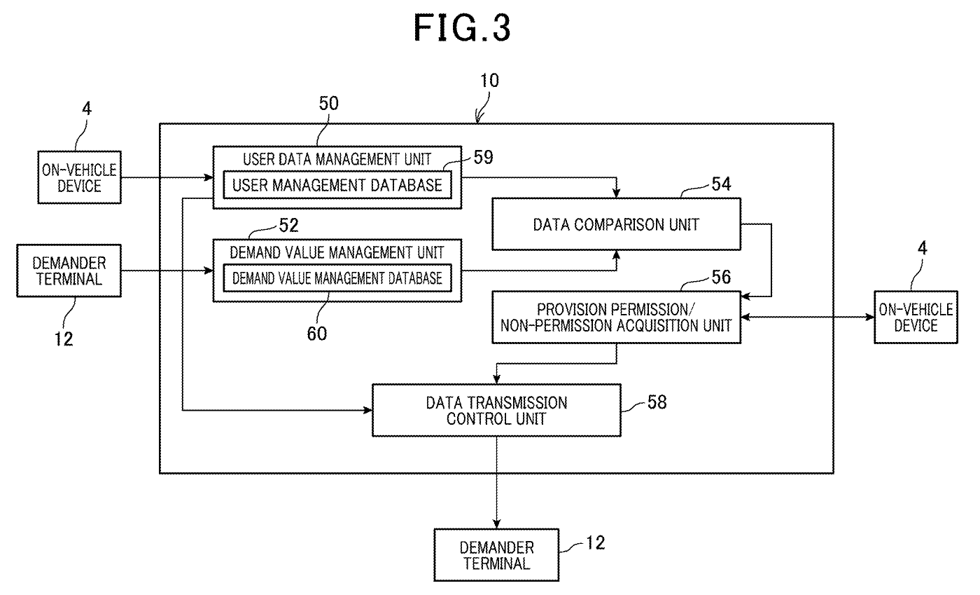

FIG. 3 is a block diagram showing a functional configuration of the data delivery control device 10.

The data delivery control device 10 comprises a user data management unit 50, a demand value management unit 52, a data comparison unit 54, provision permission/non-permission acquisition unit 56, and a data transmission control unit 58. The data delivery control device 10 is a server computer comprising a processor such as a CPU or an MPU, a memory device such as a ROM or a RAM, a data storage such as an HDD or an SSD, and a communication device which can be connected to the telecommunication lines 16. The functions described in FIG. 3 are performed by the processor executing software programs stored in the memory device. The functions of the data delivery control device 10 may be divided and separately assigned to a plurality of server computers.

The user data management unit 50 manages the collected data 18 received by the communication device from each on-vehicle device 4. More specifically, the user data management unit 50 accumulates the collected data 18 in the data storage.

In addition, the user data management unit 50 manages the user U on a user management database 59. The user management database 59 is composed of the data stored in the data storage. In the user management database 59, the user U, the cars 2 and on-vehicle device 4, and the collected data 18 collected from the car 2 in question are mapped, so that the car 2 and on-vehicle device 4 from which the collected data 18 is originated, and the user U, can be identified. The information concerning the on-vehicle device 4 under management of the user management database 59 includes its address by which various types of data are transmitted from the data delivery control device 10 through the telecommunication lines 16.

The demand value management unit 52 manages the demand values for data demanded by a demander who uses the collected data 18, and it does so on a demand value management database 60.

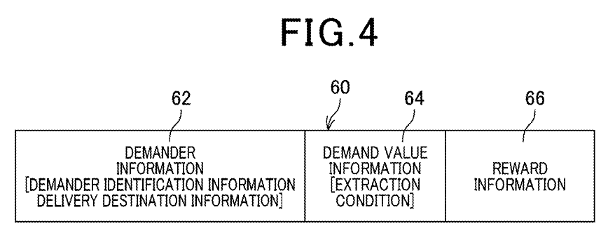

FIG. 4 is a schematic view showing a configuration of the demand value management database 60.

The demand value management database 60 manages demander information 62, demand value information 64, and reward information 66 with correspondences assigned among them, and resides in the data storage.

The demander information 62 concerns demanders. The demander information 62 comprises at least a demander identification (for example, name) for identifying each demander and a delivery destination information to which the demand-matched data 19 is to be delivered. Any mode of delivery may be used to deliver the demand-matched data 19 only if it is possible for the demander to obtain the demand-matched data 19 by the demander terminal 12. For example, the mode of delivery may be transmission by e-mail, FTP transfer, downloading from a certain web site, or uploading to a cloud storage associated with the demander. The delivery destination information contains an address of the delivery destination for demand data on the basis of the mode of delivery. The demander obtains the demand-matched data 19 delivered to that address by the demander terminal 12 for its appropriate uses.

The demand value information 64 concerns demand values in demands of demanders. For demand value information 64, extraction conditions that enable the extraction of demanded data from the collected data 18 are used. The extraction conditions are set by conveniently combining any types of information that can be contained in the collected data 18, e.g., a vehicle category of a car 2, a travel distance, a travel time, travel period, a travel area, a trouble code, and the lighting up of a warning light. By setting extraction conditions, the demander can obtain, for example, the status of occurrence of troubles in a cold season or in a cold region, or the status of occurrence of troubles on the basis of travel time and distance, for a particular vehicle category.

The reward information 66 concerns rewards offered by demanders to the user U for the provision of the collected data 18. The reward is set by the demander for each set of extraction conditions, i.e., the content of demanded data, as appropriate. The reward may be any valuable such as a coupon (discount ticket) that may be used for the purchase of a replacement for, maintenance/servicing of, a car 2, or a coupon for novelty goods.

Back to FIG. 3, the data comparison unit 54 compares the collected data 18 with the demand value information 64 to extract demanded data. More specifically, the data comparison unit 54 extracts the pieces of data that meet the extraction conditions in the demand value information 64 from the collected data 18 as demanded data. The extraction of demanded data is performed at appropriate times, e.g., at regular intervals, or at times when a predetermined number of pieces of new data are accumulated.

If the data comparison unit 54 has extracted demanded data as a result of data comparison, the provision permission/non-permission acquisition unit 56 acquires permission/non-permission of the user U to provide the demanded data to the demander. More specifically, the provision permission/non-permission acquisition unit 56 identifies the address of the on-vehicle device 4 from which the collected data 18 including the demanded data has originated on the base of the user management database 59. Then, the provision permission/non-permission acquisition unit 56 generates an inquiry message 70 about the user's permission to provide the data to the demanding demander, and sends the inquiry message 70 to the address of the on-vehicle device 4. The inquiry message 70 contains the content of the data to be provided to the demander (for example, the content of the demand value information 64), and the name of the demander, and the reward to be given by the demander for the provision of the data, in which the reward information is identified on the demand value management database 60.

The provision permission/non-permission acquisition unit 56 manages the reply of the user U to the inquiry message 70. More specifically, the provision permission/non-permission acquisition unit 56 receives reply data 21 indicating the user U′s reply to the inquiry message 70 from the on-vehicle device 4 via the telecommunication lines 16, and manages the permission/non-permission to provide the demanded data according to the reply data 21.

The inquiry message 70 may be sent at any time, and is sent at appropriate times when the data comparison unit 54 extracts demanded data.

The reply to the inquiry message 70 may be fetched at any time, and some lag between sending the inquiry message 70 and receiving a reply to it is tolerable.

The data transmission control unit 58 delivers the demand-matched data 19 to the demander terminal 12 via the telecommunication lines 16 according to the user U's reply obtained by the provision permission/non-permission acquisition unit 56. More specifically, if the provision permission/non-permission acquisition unit 56 has obtained the user U's reply indicating his or her permission to provide the demand-matched data 19, the data transmission control unit 58 identifies the delivery destination information concerning the demand-matched data 19 on the demand value management database 60, and transmits the demanded data to the destination indicated in the information.

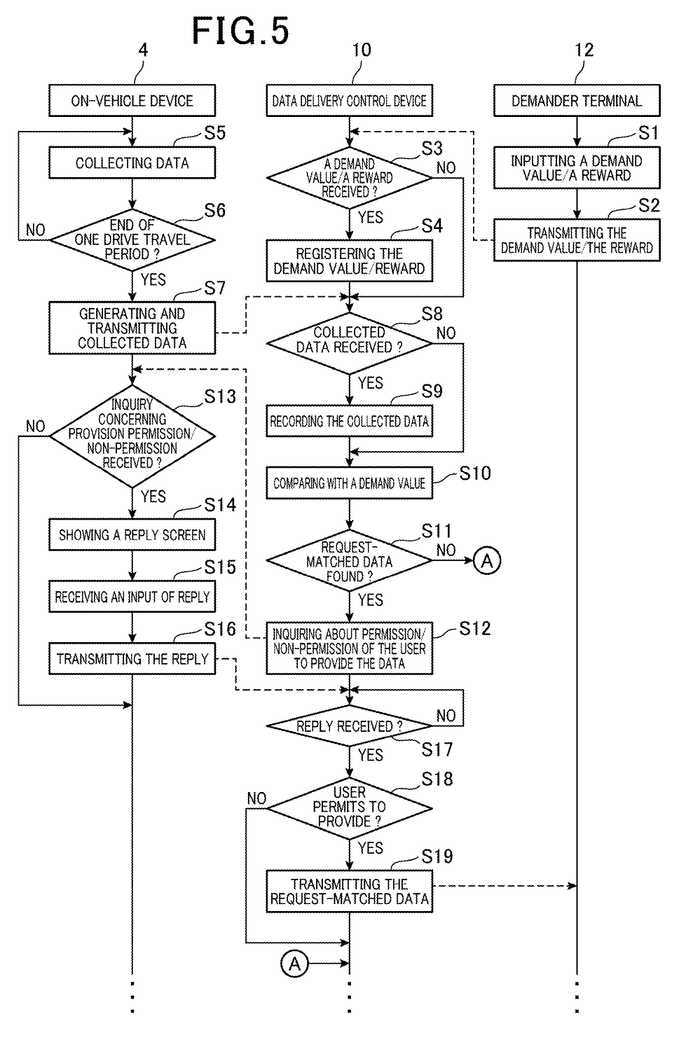

FIG. 5 is a sequence chart showing the operations of a data delivery system 1.

Assume that information concerning the car 2 and information concerning the on-vehicle device 4 have been registered in the user management database 59 of the data delivery control device 10, and the demander information 62 has been registered in the demand value management database 60.

If a demander desires to use pieces of data contained in the collected data 18, he or she operates the demander terminal 12 to input demand values that are appropriate in view of the use of the pieces of data, and a reward appropriate for the provision of the pieces of data matched with the demand value (step S1).

For example, if a manufacturer of a car 2 uses the collected data 18 with the aim of studying the status of occurrence of troubles in the car 2 in the cold region for the purpose of developments, it would set the vehicle category of the car 2, information indicating the cold region (e.g., by latitude and longitude), information related to cold climate (e.g., dates and times), etc., as the demand values. In cases where a demander changes or deletes a demand value or a reward that has been registered in the data delivery control device 10, he or she performs the operation of step S1.

When the demand values and the reward are input, the demander terminal 12 transmits them to the data delivery control device 10 (step S2).

When the data delivery control device 10 receives the demand values and the reward from the demander terminal 12 (step S3, and Yes), it records them into the demand value management database 60 (step S4).

The on-vehicle device 4 collects various types of data from each of the electronic control units 22 connected to the CAN 20 (step S5). The data collection operation continues at least during the period when the ignition key to the car 2 is in the on position. Then, when the ignition key is turned into the off position, when the one drive ends (step S6, and Yes), the on-vehicle device 4 puts the pieces of data collected during the one drive together into the collected data 18, and transmits the collected data 18 to the data delivery control device 10 (step S7).

As described above, the collected data 18 contains information concerning the car 2 (trouble code indications, the history of lighting up of warning lights, vehicle conditions, etc.), and such information is automatically collected, sent to, and accumulated in, the data delivery control device 10. Making the collected data 18 available to demanders would allow them efficiently to grasp the status of the car 2 and analyze the cause of a trouble in the car 2 when it occurs, using the collected data 18.

When the data delivery control device 10 receives the collected data 18 from the on-vehicle device 4 (step S4, and Yes), the user data management unit 50 accumulates the collected data 18 into the data storage, and records information concerning the collected data 18 into the user management database 59 to manage the collected data 18 (step S9).

Then, in the data delivery control device 10, the data comparison unit 54 compares the collected data 18 with the demand values (step S10). It is preferable that the comparison of such data with such values only be performed if at least one of the condition that a new piece of collected data 18 is stored, the condition that a new demand value is registered, and the condition that an existing demand value is changed is satisfied so that unnecessary comparison operations can be eliminated.

If the result of the comparison by the data comparison unit 54 indicates that the demand-matched data 19 that corresponds to a demand value is included in the collected data 18 (step S11, and Yes), the provision permission/non-permission acquisition unit 56 inquires of the user U whether he or she permits or not to provide the demand-matched data 19 to the demander (step S12). More specifically, the provision permission/non-permission acquisition unit 56 generates the inquiry message 70 and transmits it to the on-vehicle device 4. When the provision permission/non-permission acquisition unit 56 generates the inquiry message 70, it obtains information concerning the demander, the content of the data to be provided to the demander, and the reward to be paid by the demander for the provision of the data by referring to the demand value management database 60, and includes the obtained information in the inquiry message 70.

When the on-vehicle device 4 receives the inquiry message 70, in other words, the data delivery control device 10 inquires of the user about permission/non-permission to provide the data, (step S13, and Yes), the response control unit 44 shows the reply screen 47 on the touch panel display 5 (step S14).

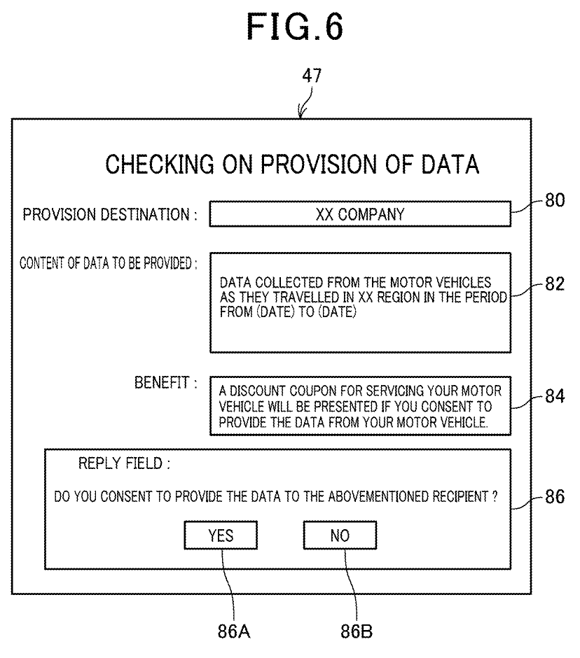

FIG. 6 shows an example of the reply screen 47.

The reply screen 47 has a provision destination display area 80, a data-content display area 82, a benefit display area 84, and a reply area 86.

The provision destination display area 80 shows the demander or provision destination to whom the collected data 18 (i.e., the demand-matched data 19) is to be provided. The data-content display area 82 shows the content of the collected data 18 (i.e., that of the demand-matched data 19) to be provided to the provision destination. The benefit display area 84 shows a benefit for the user U from providing the provision destination (demander) with the content of the collected data 18 as shown in the data-content display area 82, the benefit being the abovementioned reward. The reply area 86 is to be used by the user U to give his or her reply on whether he or she permits to provide the data, the area 86 having an “Yes” button 86A and a “No” button 86B which can be operated by the user.

If the user U will give his or her permission to provide the data (i.e., he or she will permit providing the data) after he or she has learned the provision destination of the collected data 18, the content of the data to be provided, and the benefit from the showing on the reply screen 47, he or she presses the “Yes” button 86A on the reply area 86, or if the user U will not give his or her permission to it (he or she will not permit providing the data), he or she presses the “No” button 86B on the reply area 86.

As described above, the collected data 18 is user personal information which includes information concerning the cars 2 and information concerning an act of the user U, and the showing on the reply screen 47 allows the user U to learn what personal information in the collected data 18 is to be provided, to whom it is to be provided, and the benefit from providing it, and decide permission/non-permission to provide it; therefore, it is made possible for the user to only allow the provision of such data with intent.

Back to FIG. 5, when the response control unit 44 receives the user's operation on the reply area 86 (step S15), it transmits the reply data 21 indicating the reply (i.e., permission/non-permission to provide the data) to the data delivery control device 10 (step S16).

When the data delivery control device 10 receives the reply data 21 from the on-vehicle device 4 (step S17), the data transmission control unit 58 transmits the demand-matched data 19 according to the result of the user U's reply.

More specifically, if the user U permits providing the data (step S18, and Yes), the data transmission control unit 58 will transmit the demand-matched data 19 to the address designated in the delivery destination information in the demand value management database 60 (step S19). This makes it possible for the demander to receive the demand-matched data 19 through the demander terminal 12.

On the other hand, if the user U refuses to provide the data (step S18, and No), the data transmission control unit 58 will not transmit the demand-matched data 19. This prevents the provision of the data against the user U's intent.

In the case that the user U refuses to provide the data, the data delivery control device 10 may notify the demander of the user U's refusal on the demand-matched data 19 by transmitting a message to that effect to the demander terminal 12. That may allow the demander to know whether the demand-matched data 19 exists and reconsider the reward.

The data delivery control device 10 repeats the process illustrated in FIG. 5; and thus, sends the user U an inquiry concerning his or her permission/non-permission to provide the demand-matched data 19 each time the demand-matched data 19 is newly extracted, and provides the demand-matched data 19 to the demander according to the user U's reply.

As described heretofore, this embodiment would produce the following advantageous effects.

In this embodiment, if the demand-matched data 19 which corresponds to a demand value is included in the collected data 18, the data delivery control device 10 transmits the demand-matched data 19 to the demander terminal 12 if the user U permits providing the demand-matched data 19.

Thus, the demand-matched data 19, which is personal information concerning the user U, is transmitted according to the user U's permission/non-permission, and this prevents the transmission of the data against the user U's intent.

In this embodiment, the data delivery control device 10 manages a reward offered by the demander for the provision of the demand-matched data 19, and therefore, the demander can register an appropriate reward for the provision of the data into the data delivery control device 10, putting it under the management of the data delivery control device 10.

In this embodiment, the data delivery control device 10 transmits the reward to the user U so as to make an inquiry concerning the user U's permission/non-permission to provide the demand-matched data 19 after the reward is presented to the user U.

This makes it possible for the user U to decide permission/non-permission to provide the data, taking the reward into consideration.

In this embodiment, the collected data 18 is taken in the period between the time of the ignition key to the car 2 being turned into the on position and the time of the ignition key to the car being turned into the off position, which is a unit period for data collection.

In other words, the period from the ignition key into the on position to the ignition key into the off position, that is, one drive period (ride/drive period), is considered as a unit period, and a group of pieces of data taken at any time during that drive period is organized into one set of collected data 18.

This feature allows the demander to obtain and use a group of pieces of data collected at any time during that drive period by setting that drive period as a demand value of unit period.

If, however, the collected data 18 is taken for one drive period (ride/drive period), the data may not be organized for a period from the ignition key to the car 2 into the on position to the ignition key into the off position. If, for example, the driver turns off the ignition key for a short stop and turns it on again during a drive, the collected data 18 may not organized according to those on/off operations.

In this embodiment, the collected data 18 includes location information on the cars 2, and the demander can obtain and use the collected data 18 concerning the cars 2 that have travelled on any location or in any geographical area.

In this embodiment, the collected data 18 includes data/time information, and the demander can obtain and use the collected data 18 concerning the cars 2 that travelled at any time or in any period.

The abovementioned embodiment is only an example of an aspect of the present invention, and any variation and any application of the present invention is possible without departing the scope of the present invention.

For example, the on-vehicle device 4 may obtain information concerning the user U from an electronic device carried by the user U and put it into the collected data 18. The electronic device may be, e.g., a mobile phone, a smart phone, a mobile PC, a portable music player, or a smart watch. Information concerning the user U may be his or her sex, age, hobby, matters of interest, etc. Including information concerning the user U in the collected data 18 would allow the demander to learn what type of user U uses what car 2, and how, from the collected data 18 to use it for marketing.

Furthermore, the on-vehicle device 4 may be configured to obtain only information permitted or selected by the user U from such electronic devices.

For the on-vehicle device 4 to obtain data from such electronic devices, any method can be used, for example, through cable connection or by wireless communication connection.

Furthermore, the data delivery control device 10 may transmit the inquiry message 70 not to the on-vehicle device 4 but a predetermined address associated with the user U. The predetermined address may be an e-mail address, an SNS account, or the like. In that case, the user U may check the inquiry message 70 that has arrived at the predetermined address through an electronic device such as a smartphone or a PC, and return his or her reply concerning permission/non-permission to provide the data to the data delivery control device 10 by an appropriate method. The appropriate method may be, e.g., sending a return message to the inquiry message 70, accessing a homepage for inputting a reply and inputting his or her reply, or having an electronic device execute a certain application program to perform a reply input function.

Furthermore, to accumulate the collected data 18 in the data delivery control device 10, the blockchain technology may be used.

More specifically, blockchain data in which one set of collected data 18 is one block is defined for each on-vehicle device 4, and, each time the data delivery control device 10 receives collected data 18 from one on-vehicle device 4, it joins the collected data 18 to the end of the blockchain data of the on-vehicle device 4. Using the blockchain technology to accumulate the collected data 18 would enhance the reliability of each set of collected data 18. The collected data 18 as blockchain data may be distributed to be stored in a plurality of computers, which makes it easier to back up the collected data 18 and reduce the risk of losing it.

In addition, each time new collected data 18 is joined to the blockchain data, the plurality of computers check the validity of the data, and therefore, tempering of the collected data is prevented.

The history of provision of information to the demander terminal 12, as well as the collected data 18, may be included in the blockchain data. The history of provision of information may include, e.g., a history of inquiries made by the data delivery control device 10 concerning the user's permission/non-permission to provide data (FIG. 5: step S12), a history of reply made by the user U (FIG. 5: steps S15 and S16), and a history of transmissions of the demand-matched data 19 performed by the data delivery control device 10 (FIG. 5: step S19). Such data may be joined to the blockchain data at any time; however, it is preferable that it be joined sequentially each time an event for which data is recorded occurs. Including the history of provision of data in the blockchain data would help the data delivery system 1 to record the activities for the provision of the collected data 18 with reduced risks of tempering, loss, etc. of the data.

Furthermore, the configuration of the data delivery control device 10 is not limited to that composed of one or more server computers, but it may be configured as a backend device for a server computer which can communicate with the on-vehicle device 4 and the demander terminal 12 via the telecommunication lines 16.

Furthermore, the on-vehicle device 4 may be an on-vehicle apparatus such as a navigation device or an audio device.

Furthermore, in cases where an arbitrarily selected information processing device, e.g., a smartphone or a tablet PC, is communicably connected to the on-vehicle device 4, the information processing device may be equipped with part or the whole of the functions of the on-vehicle device 4 for the transmission of the collected data 18 (e.g., the functions of the user interface unit 39 and response control unit 44). The information processing device has a computer, a user input device (e.g., a keyboard or a touch panel display), a display device (a liquid-crystal panel or an organic EL panel), a processor such as a CPU or an MPU, a memory device such as a RAM or a ROM, a storage such as an HDD or an SSD, an interface circuit for connection with peripheral devices, a wireless communication device connected by wireless communication with the telecommunication lines 16, etc.

The present invention can be applied to not only the cars 2 but also to any vehicle, e.g., an aircraft, a watercraft, or a self-propelled vehicle.

### REFERENCE SIGNS LIST

1 Data delivery system
2 Car (vehicle)
4 On-vehicle device (information processing device)
5 Touch panel display
10 Data delivery control device
12 Demander terminal
16 Telecommunication line
18 Collected data (user personal information)
19 Demand-matched data
21 Reply data
30 Control unit
32 Location detection unit
34 Clocking unit
38 Wireless communication unit
39 User interface unit (interface unit)
40 Data collection control unit
42 Collected data transmission control unit
44 Response control unit (transmission unit)
47 Reply screen
50 User data management unit
52 Demand value management unit
54 Data comparison unit
56 Provision permission/non-permission acquisition unit
58 Data transmission control unit
62 Demander information
64 Demand value information
66 Reward information
70 Inquiry message
U User

What is claimed is:

1. A data delivery control device, comprising:
a user data management unit which manages user personal information containing information concerning a vehicle and information concerning a user's act of the vehicle;
a demand value management unit which manages a demand value for the user personal information which is demanded for by a demander;
a data comparison unit which compares the user personal information under management of the user data management unit with the demand value under management of the demand value management unit;
a provision permission/non-permission acquisition unit which, if a result of data comparison by the data comparison unit indicates that the user personal information includes a demand-matched data that matches with the demand value, acquires permission/non-permission of the user to provide the demand-matched data; and
a data transmission control unit which transmits the demand-matched data to allow the demander to obtain the demand-matched data according to the user's permission/non-permission acquired by the provision permission/non-permission acquisition unit.

2. The data delivery control device according to claim 1 wherein the demand value management unit manages a reward offered by the demander for the provision of the demand-matched data.

3. The data delivery control device according to claim 2 wherein the provision permission/non-permission acquisition unit presents the reward to the user and inquires of the user about permission/non-permission to provide the demand-matched data.

4. The data delivery control device according to claim 1 wherein the vehicle is a car, and the user personal information is organized into data for a unit period between an ignition key being turned into the on position and the ignition key being turned into the off position in the car.

5. The data delivery control device according to claim 4 wherein the information concerning the user's act includes information concerning a location of the car.

6. The data delivery control device according to claim 4 wherein the information concerning the user's act includes date and time information.

7. An information processing device comprising:
an interface unit to which the user can input his or her permission/non-permission to provide the demand-matched data identified in the comparison by the data delivery control device according to claim 1, and
a response control unit which transmits the permission/non-permission to provide the demand-matched data to the data delivery control device according to the input by the user to the interface unit.

8. A method for data delivery control in a data delivery control device having a user data management unit which manages user personal information containing information concerning a vehicle and information concerning a user's act of the vehicle, the method comprising:
a step of obtaining a demand value for the user personal information demanded for by a demander;
a step of comparing the user personal information under management of the user data management unit with the demand value,
a step of, if a demand-matched data which matches with the demand value is included in the user personal information, acquiring the user's permission/non-permission to provide the demand-matched data;
a step of transmitting the demand-matched data to allow the demander to obtain the demand-matched data according to the user's permission/non-permission.

9. The method for data delivery control according to claim 8, further comprising a step in which the demander offers a reward for the provision of the demand-matched data.

10. The method for data delivery control according to claim 9, wherein the reward is presented to the user; the user is inquired of about permission/non-permission to provide the demand-matched data; and the user's permission/non-permission is obtained on the basis of the user's reply to the inquiry.
